(19) United States
(12) Patent Application Publication
(10) Pub. No.: US 2026/0349965 A1
(43) Pub. Date: Nov. 5, 2026

(54) DEVICES, SYSTEMS, AND METHODS FOR INTELLIGENT, CLOUD-BASED DATA INTEGRATIONS

(71) Applicant: The PNC Financial Services Group, Inc., Pittsburgh, PA (US)

(72) Inventors: Randal J. Heuler, Pittsburgh, PA (US); Patrick Chan, Pittsburgh, PA (US); Duane Crilley, Pittsburgh, PA (US)

(21) Appl. No.: 19/197,439

(22) Filed: May 2, 2025

(51) Int. Cl. G06F 16/178; G06F 16/182

(52) U.S. Cl. CPC G06F 16/178; G06F 16/182

(57) ABSTRACT

A computer-implemented method for updating files hosted by a cloud-based platform is disclosed herein. The method can include receiving a target file with at least one updated data entry associated with a customer or customer account. The method can further include assessing a data format of the target file and generating a triggering event based on the data format of the target file. If the data format of the target file includes a property name and value, the triggering event can be configured to cause a stream listener of the cloud-based platform to process the at least one updated data entry of the target file without a merge operation. However, if the data format of the target file includes delimiters and headers, the triggering event can be configured to cause the stream listener of the cloud-based platform to perform a merge operation prior to processing the at least one updated data entry of the target file.

### BACKGROUND

Existing cloud-based platforms generally host and/or execute files on behalf of a user. For example, instead of requiring a user to obtain the requisite hardware necessary to host and/or execute such files on its own premises, cloud-based platforms enable the user to utilize its own, remotely located architecture. Not only do such platforms eliminate the need to obtain, maintain, and update its own architecture, but they facilitate the central construction and deployment of files, customer service portals, workflow automations, and/or case management applications, which are typically configured for collective and collaborative use across a corporate enterprise. Accordingly, cloud-based platforms are commonly used at banks, insurance companies, healthcare organizations, and governments to streamline and centralize their operations. For example, banks often utilize such platforms for customer onboarding. Instead of buying their own servers, hiring cloud engineers, and installing applications manually, such banks can utilize a cloud-based platform (e.g., PEGA Cloud, Oracle Fusion Cloud, Salesforce Service Cloud, Appian, ServiceNow, OutSystems, etc.) to develop, host, manage, and execute their customer onboarding applications.

However, use of cloud-based platforms can result in certain technological problems. For example, conventional cloud-based platforms and methods of use are susceptible to the so-called “race condition,” in which two or more transactions or operations attempt to modify the same file concurrently. This can cause data loss and potential corruption since the outcome of the update will depend on the unpredictable order of execution. One transaction might simply overwrite the changes made by another. Additionally, when working with and synchronizing multiple files (e.g., mortgage files, withdrawal files, deposit files, etc.) and large amounts of data, operations tend to be sequential and performed across multiple days. Conventional cloud-based platforms and methods inefficiently synchronize all entries in every related file, even when only a single entry has been altered. Given these problems, it can be difficult to discern whether data is properly synchronized, as no “gold copy” of the data for comparison, which tracks what has been changed or updated in time. Accordingly, there is a need for devices, systems, and methods for intelligent, cloud-based data integrations.

### SUMMARY

In order to prevent potential race conditions from corrupting the integrity of a target file update, the present disclosure describes a computer-implemented method for updating files hosted by a cloud-based platform. For example, upon receipt of a target file with at least one updated data entry associated with a customer or customer account, a data format of the target file can be assessed. A triggering event can be generated based on the assessed data format of the target file and the update can be processed based on the triggering event. For example, if the data format of the target file includes a property name and value, stream listeners of a cloud-based platform, such as PEGA cloud, can process at least one updated data entry of the target file without a merge operation. However, if the data format of the target file includes delimiters and headers, the stream listeners of the cloud-based platform can perform a merge operation prior to processing at least one updated data entry of the target file.

Additionally, to enhance the efficiency and efficacy of file synchronization, the present disclosure describes another computer-implemented method for updating files hosted by a cloud-based platform. Once again. the method can include receiving a target file with at least one updated data entry associated with a customer or customer account. For example, a key of the target file can be compared to a key of a reference file. Likewise, the content of the target file can be compared to content of the reference file. Based on the comparisons, at least one updated data entry of the target file can be advanced. Any mismatches between he target and reference files can result in an attribute classification and buffer that, upon being filled, could also result in the advancement of the at least one updated data entry of the target file.

Unlike conventional systems that perform bulk merges or uncoordinated updates, the system of the present invention can intelligently distinguish between file formats and apply selective merge operations only when necessary. This not only prevents data corruption due to race conditions but also reduces computational overhead and bandwidth usage, thereby improving performance in high-volume cloud platforms. These and other benefits that can be realized through various embodiments of the present invention will be apparent from the description that follows.

### FIGURES

Various embodiments of the present invention are described herein by way of example in conjunction with the following figures.

FIG. 1 is a block diagram of a system for intelligent, cloud-based data integrations according to one non-limiting aspect of the present disclosure.

FIG. 2 is a configuration diagram associated with a cloud-based platform of the system of FIG. 1 according to one non-limiting aspect of the present disclosure.

FIG. 3 is a flow diagram of a method associated with the configuration of FIG. 2 according to one non-limiting aspect of the present disclosure.

FIG. 4 is a configuration diagram associated with an enterprise network of the system FIG. 1 according to one non-limiting aspect of the present disclosure.

FIG. 5 is a flow diagram of a method associated with the configuration of FIG. 4 according to one non-limiting aspect of the present disclosure.

FIG. 6 is a computer system configured for use with the system of FIG. 1 according to various non-limiting aspects of the present disclosure.

### DESCRIPTION

Services and files used by cloud-based platforms, such as Customer Interaction Management (CIM), typically use tables for different dimensions of the customer and/or customer accounts. For example, these tables may include information associated with customer transactions, customer demographics, and/or customer services, amongst others. Such information is generally consolidated into a few physical tables by cloud-based platforms. For example, one table may include all customer data and another table may include all account data. However, conventional systems, import of such data is done via separate jobs, each created for one of the many dimensions. This means all data elements for a dimension need to be updated and merged regardless of whether or not they actually changed. This process ensures that existing data is not altered when updating new data. Such processing and merge operations can take up to five hours each day. Accordingly, the present disclosure contemplates devices, systems, and methods configured to reduce the overall end-to-end processing time, eliminate schedule dependencies, reduce the need to update the same record multiple times, and update specific data properties in a files hosted by a cloud-based platform without having to extract all data for a dimension only to update a few data properties for a table row, all while mitigating the risk of race condition.

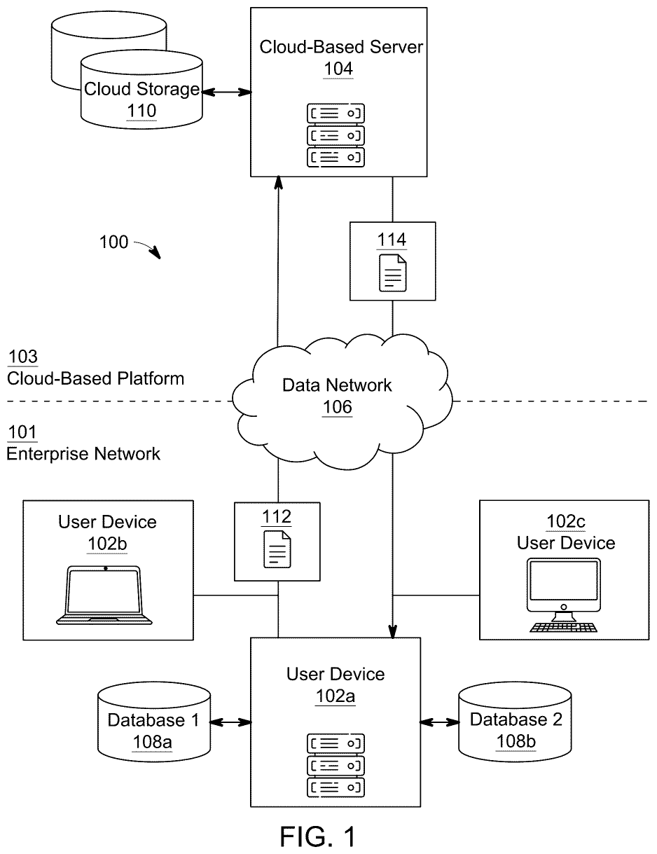

For example, FIG. 1 depicts a system 100 for intelligent, cloud-based data integrations. According to the non-limiting aspect of FIG. 1, the system 100 can include a plurality of user devices 102_{a-c} and a plurality of databases 108ₐ, 108_{b} communicatively coupled on an enterprise network 101. The enterprise network 101, for example, can include a large-scale, integrated network configured to enable organizations and their employees work, interact, and perform their core business processes and operations. For example, the enterprise network 101 can include a network server 102ₐ of the plurality of user devices 102_{a-c} that is local to the organization, or on the organization's premises (e.g., “on-prem”). The network server 102ₐ, however, can be communicatively coupled to the cloud-based platform 103 via a data network 106. The network server 102ₐ can include memory that stores a data synchronization and delta engine that, when executed by a processor, causes the network server 102ₐ to perform the functionality disclosed herein.

In further reference to FIG. 1, the system 100 can further include a cloud-based server 104 and one or more databases 110 configured for cloud-based storage, which may be communicatively coupled on the cloud-based platform 103. For example, the cloud-based platform 103 can include a fully managed, scalable cloud platform designed for low-code applications and intelligent workflows. The cloud-based platform 103 can be beneficial for the enterprise network 101 because the cloud-based platform 103 can include built-in security, automated operations, and seamless updates, which can enable users on the enterprise network 101 to deploy and manage applications without the complexity of traditional infrastructure management. For example, the cloud-based platform 103 can provide a CIM service, which can allow the enterprise network 101 to orchestrate real-time, personalized customer engagement for onboarding, transactions

Still referring to FIG. 1, the cloud-based platform 103 can be communicatively coupled to the enterprise system 101 via a data network 106. The data network 106, for example, can include any conventional means to transmit data between the enterprise network 101 and the cloud-based platform 103, including a wired connection (e.g., a local area network), a wireless network (e.g., Wi-Fi®), a cellular network, and/or a satellite connection, amongst others. As depicted in FIG. 1, the plurality of user devices 102_{a-c} can be configured to transmit files 112, such as target files that include at least one updated data entry, and receive files 114 to and from the cloud-based server 104 of the cloud-based platform 103. These files, for example, can include tables with different dimensions of a customer and/or customer account, as previously explained. However, it shall be appreciated that, the fact that any of the plurality of user devices 102_{a-c} can be updating one or more dimensions of the same table at the same time introduces the risk of a race condition.

According to FIG. 1, the one or more databases 110 configured for cloud-based storage can be configured to store a reference copy and a variable-length version of each of the files 112, 114. Such copies can be in a pipe-delimited format, for example, including headers. However, other delimiting characters (e.g., commas, tabs, etc.) may be used. However, it shall be appreciated that using a pipe to delimit entries can avoid confusion, as the pipe character is less likely to appear in the substantive data itself, reducing the risk of conflation during processing. The headers, for example, can be included in the first row of each table and used to describe what each field of data represents.

According to some non-limiting aspects, the cloud-based platform 103 of FIG. 1 may be a vendor provided solution that requires in-place data to be present for processing, operational performance. It may require federated data to be placed in single table structures. For example, the cloud-based platform 103 may utilize components called “data jobs,” which are configured to accept incremental updates (in a specified format) to individual data tables where only changed columns needed to be inputted. Absent the data synchronization and delta engine, the cloud-based platform 103 may update changed columns for a single row by merging any existing columnar data with the incremental column updates and replace the entire row. Data jobs may be designed to run in parallel and also update records/rows in configurable batches for maximum performance/throughput. However, when different dimension (groups of columns/segments) updates for a single table are executing simultaneously, the cloud-based platform 103 may experience a race condition, where the columns for an existing row (or rows) with the same key values (as any competing process) can be merged prior to updates occurring.

For example, a first process may require the update of columns 1,2,3 & 6 of table X for key Y at the same time that a second process may require the update of columns 4,5 of table X also for key Y. Both processes will read columns 1, 2, 3, 4, 5, and 6 of table X for key Y prior to updating their respective columns and replacing the entire row. Thus, the changes for the process that finishes first will be lost. Additionally, the cloud-based platform 103 may require an update to table data in real-time. Race conditions, therefore, may occur between the real-time process and batch and/or other real-time processes updating different columns for the same table and keyed row at the same time.

However, the data synchronization and delta engine employed by the network server 102ₐ can help eliminate race conditions for both batch and real-time processes while maintaining and even enhancing performance of the cloud-based platform 103, allowable Java extensions, and on-premises data preparation processes employed via the enterprise network 101 to essentially eliminate the merging of data prior to update. For example, the data synchronization and delta engine employed by the network server 102ₐ can compare variable-length, pipe-separated data sets containing headers providing configurable output formats and generate detailed reports for data differences analysis.

As depicted in FIG. 1, the plurality of databases 108ₐ, 1086 of the enterprise network 101 can store similar files and the network server 102ₐ may be configured to substantially mirror the cloud-based platform 103 in functionality, using the same structured file formats, control parameters, and logic. However, via the data synchronization and delta engine employed by the network server 102ₐ, the enterprise network 101 can perform a process that efficiently identifies and synchronizes relevant entries across related files, even when only a single entry has been altered. This can be entirely self-contained, operating on locally stored files and generating results that remain within the organization's internal data systems. This process is well-suited for environments where data cannot leave the premises due to regulatory, privacy, or latency constraints.

In response to the files 112 sent from the enterprise network 101, the cloud-based platform 103 can also be configured for automated, daily delta and reconciliation of two sets of structured enterprise data files—typically delimited text files or partial SQL data dumps. For example, as will be described in further detail herein, the cloud-based platform 103 can be configured to compare a “gold copy,” or reference data, against cloud-hosted or variable-length files to identify inserts, updates, and deletions based on certain control parameters that dictate how the data validation, transformation, and output will be performed. According to one non-limiting aspect, this process can include the use of stream listeners to determine if a file 112 received from the enterprise network 101 necessitates an update, or a merge and update. For example, the steam listeners can monitor incoming events or files and determine if the received file 112 has simple updates or requires multiple existing records to be consolidated before updating. In essence, the cloud-based platform 103 can be configured to manage multiple updates effectively and efficiently being provided (potentially, simultaneously) by the user devices 102_{a-c} on the enterprise network 101 and can mitigate the risk of race condition.

In summary, due to the data synchronization and delta engine employed by the network server 102ₐ, the system 100 of FIG. 1 can be configured to perform staged, event-driven, validated update models in lieu of riskier, intermediate updates, which results in more reliable, high-volume processes (e.g., customer onboarding, KYC updates, etc.) that eliminate the risk of race condition. Whereas conventional devices, systems, and methods allow for immediate, direct updates, do not perform any conflict checking, and are prone to race conditions, the system 100 of FIG. 1 provides for staged, validated updates, is capable of duplicate/drop protection, and provides controlled, event-driven updates. In other words, instead of allowing all users across an enterprise to update the same files, the system 100 of FIG. 1 forces the submission of edits and then merges and applies those edits to existing files for a more efficient update process.

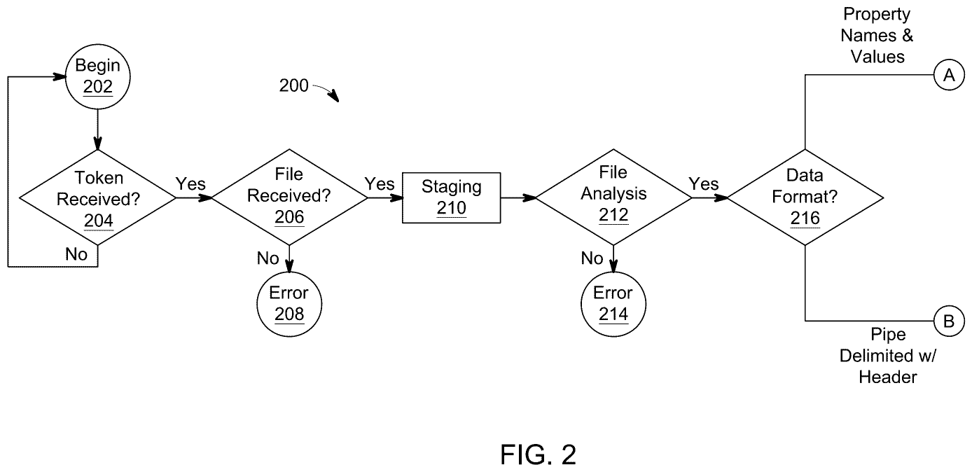

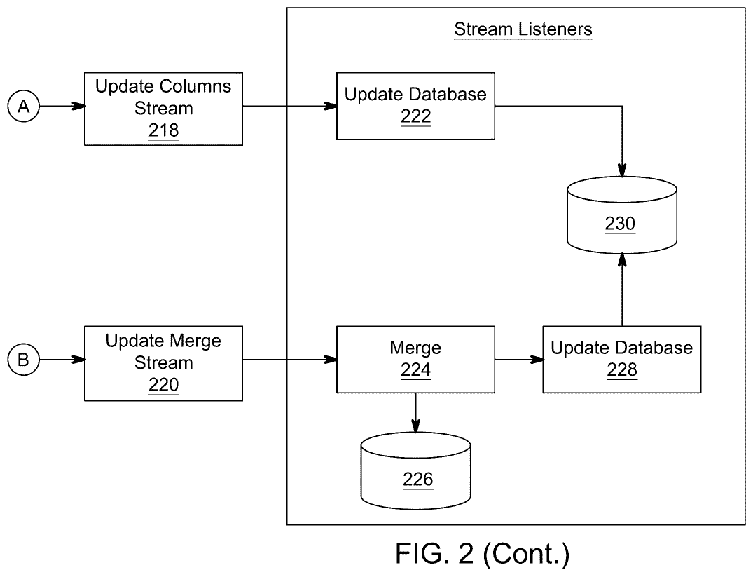

FIG. 2 depicts a diagram of a configuration 200 employed by the cloud-based platform 103 of the system 100 of FIG. 1. Specifically, the configuration 200 allows for elimination of the race condition (for both batch and real-time processes) by eliminating the merging of data prior to update. The configuration 200 of FIG. 2, for example, can facilitate the comparison of variable-length, pipe-separated data sets containing headers providing configurable output formats and detailed reports for data differences analysis. For example, the configuration 200 can cause the cloud-based platform 103 (FIG. 1) to assess 204 whether a token has been received prior to beginning 202 the process. A token, for example, may include a security credential ensuring that a requested update to the file 112 (FIG. 1) is actually authorized by the enterprise network 101 (FIG. 1). Upon receiving a token, the configuration 200 can cause the cloud-based platform 103 (FIG. 1) to determine 206 whether the file 112 (FIG. 1) was received from the enterprise network 101 (FIG. 1). If the file 112 (FIG. 12) was not received, the configuration 200 can cause the cloud-based platform 103 (FIG. 1) to conclude 208 that an error has occurred and terminate the process.

According to FIG. 2, assuming the file 112 (FIG. 1) is received by the cloud-based platform 103 (FIG. 1), the configuration 200 may cause the cloud-based platform 103 (FIG. 1) to stage 210 the file 112 (FIG. 1). Staging, for example, can include temporarily holding the incoming file 112 before actually processing or committing changes. According to some aspects, staging can further include validating, transforming, auditing, or enriching the file 112 (FIG. 1) prior to the file 112 (FIG. 1) touching the live system, sometimes via data flows, activities, or ETL pipelines. For example, an incoming file 112 (FIG. 1) may have errors (e.g., bad data, missing fields) and reconciliation may be necessary prior to processing. After staging the file, the configuration 200 may cause the cloud-based platform 103 (FIG. 1) to analyze 212 the file 112 (FIG. 1), assessing whether or not the manifest file (which normally describes the data) is the data itself. For example, if manifest=data, there is no separate manifest data and the cloud-based platform 103 (FIG. 1) can read the data file directly, assuming it has all necessary fields. The analysis can also include an assessment of whether the name of the incoming file 112 (FIG. 1) is used exactly as is it is within the one or more cloud-based storages 110 (FIG. 1) of the cloud-based platform 103 (FIG. 1). This can determine whether or not the file 112 (FIG. 1) requires re-writing. The analysis can even further include an assessment of the number of records store or reported by the cloud-based platform 103 (FIG. 1) in comparison to the file 112 (FIG. 1).

In further reference to FIG. 2, the configuration 200 may further cause the cloud-based platform 103 (FIG. 1) to assess 216 a data format of the file 112 (FIG. 1). For example, if it is determined that the file 112 (FIG. 1) includes property names and values, a stream listener of the cloud-based platform 103 (FIG. 1) that monitors the enterprise network 101 (FIG. 1) may detect an event generated by the enterprise network 101 (FIG. 1) indicating as much. Thus, the cloud-based platform 103 (FIG. 1) may simply update 220 the corresponding file in a relevant storage 230 in response to the detected event. However, if it is determined that the file 112 (FIG. 1) includes a pipe delimited format with headers, the stream listener of the cloud-based platform 103 (FIG. 1) may detect an event generated by the enterprise network 101 (FIG. 1) indicating as much and, therefore perform a merge 224 with another database 226 prior to updating 228 the relevant storage 230 in response to the detected event.

The stream listener may be implemented as an event-driven software module stored in system memory and executed by the processor. The data synchronization and delta engine may invoke the stream listener based on a format-specific triggering event to determine whether to merge incoming data entries prior to commit. These modules may interact through shared memory, messaging queues, or inter-process APIs. Accordingly, the configuration 200 can enable an on-prem data comparison and reconciliation process for enterprise file records, specifically contrasting a cloud process with an on-premises one. It determines whether or not updates are necessary, or merges prior to updates based on the specific events detected by the listeners and the file formats and content. The inputs may include a first file, or a reference “Gold Copy” in pipe-delimited format with headers, and a cloud-hosted, variable-length version of the Gold Copy, also in pipe-delimited format with headers. The configuration 200 may operate on certain parameters dictate how the process handles data validation, transformation, and output. Examples of some parameters are provided below:

### Run Control (e.g., PRM03-NYYYYN):

A: Abort on bad header or header mismatch.
B: Create SQL statements (Y=Yes, N=No, I=Inserts, U=Updates).
C: Create partial SQL (attributes and values).
D: Write out differences.
E: Use abbreviations for attributes.
F: Enable daily delta vs. reconciliation.
G: Indicates whether batch SQL mode is enabled (multi-update per record).

### Buffer Control (e.g., PRM0449-1700-22000-12000):

First segment: Pattern match batch size.
Second: Number of output buffers.
Third: Size of each output buffer.
Fourth: Size of the insert buffer.

### Tolerance Limits (e.g., PRM07-00000000-00000000-00000000):

Thresholds for inserts, deletes, and updates to prevent excessive discrepancies.

### Token and Manifest Files:

Token reference files define structure or schema mappings.
Manifest files are used for deletes and validation—used to track expected operations.

### Upsert Logic:

“Upsert” means update if the record exists; insert if it does not.

### Output:

SQL or delta files representing differences between the two data sets.
The process flags records for insert/update/delete based on field-by-field comparison.
Can generate outputs in SQL format or as delimited text.

In other words, the configuration 200 can provide an on-prem data reconciliation process that automates data consistency verification between a reference (Gold Copy) and a dynamic, possibly cloud-resident, data file. It can allow fine-grained control over update logic, tolerances for change, and buffering mechanisms, making it suitable for large-scale enterprise data environments where regular consistency checks are essential.

To determine the format of the target file, the system may inspect the file's contents and metadata. For example, the cloud-based platform can perform header inspection, delimiter recognition, or structural parsing to identify whether the file uses property-based representations (e.g., JSON with key-value pairs) or delimited structures (e.g., CSV or pipe-delimited tables with headers). This format analysis may include checking for line-based records, presence of consistent column delimiters, or structured tags. Based on the identified format, the system can map the file to a corresponding processing path. If the file comprises property names and values, the triggering event may signal the stream listener to bypass merge operations and directly apply updates. If the file comprises delimited data with headers, the triggering event may invoke a merge routine prior to committing updates to ensure consistency with existing records.

In summary, FIG. 2 depicts how data in a file can be specifically configured (e.g., pipe delimited, attribute-value format, etc.) for more efficient uploads, processing, and updates via the cloud-based platform. The file format is determined and configured by a user on the on-prem side based on configurable parameters as well as the comparison process itself. Thus, intelligence in that process can “override” the configurable parameters and provide one format over the other.

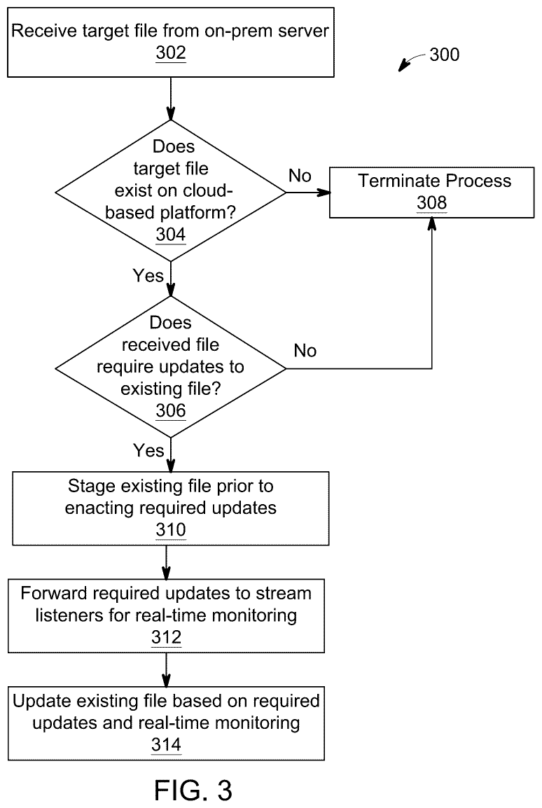

FIG. 3 is an algorithmic flow diagram of a method 300 associated with the configuration 200 of FIG. 2 according to one non-limiting aspect of the present disclosure. The method can 300 include receiving 302 a target file from an on-prem server, and determining 304 whether target file exist on cloud-based platform. If it is determined that the target file does not presently exist on the cloud-based platform, the method 300 can include terminating 308 the process. However, if it is determined that the target file does exist on the cloud-based platform, the method 300 can further include determining 306 whether the received target file requires updates to the existing file on the cloud-based platform. If it is determined that the received target file does not require updates to the existing file on the cloud-based platform, the method 300 can include terminating 308 the process. However, if it is determined that the received target file does require updates to the existing file on the cloud-based platform, the method 300 can further include staging 310 the existing file prior to enacting required updates Once staged, the method 300 can further include forwarding 312 the required updates to stream listeners for real-time monitoring. However, different events are generated based on content and format of the received file. If the content is formatted with property names and values, the method 300 updating 314 the existing file based on required updates and real-time monitoring. However, if the content is pipe delimited with headers, the method 300 can include merging the file prior to updating 314 the existing file based on required updates and real-time monitoring.

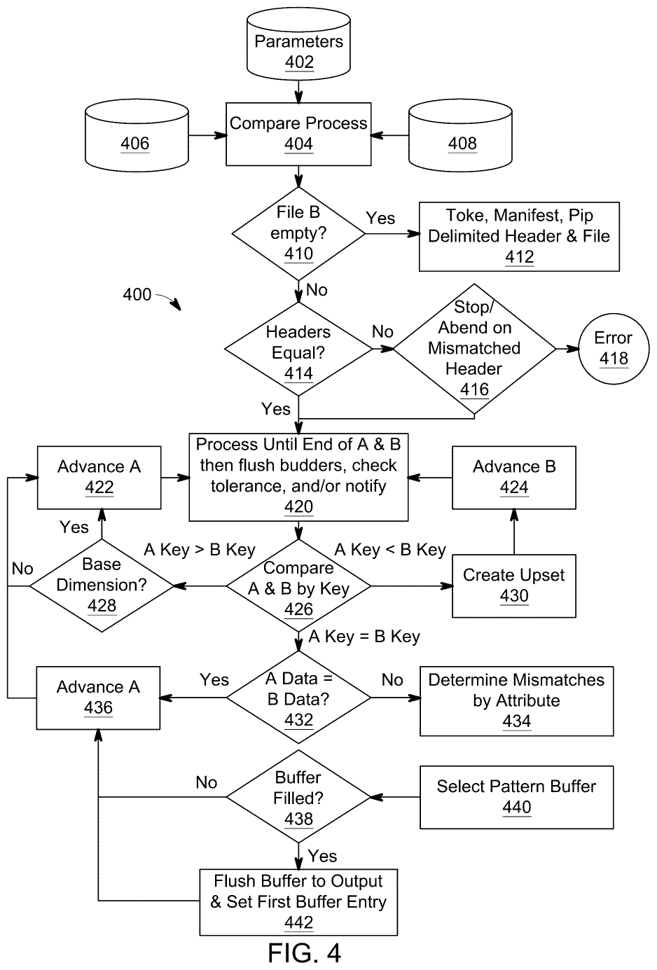

FIG. 4 is a diagram of a configuration 400 employed by the enterprise network 101 of the system 100 of FIG. 1 according to one non-limiting aspect of the present disclosure. The configuration 400 enables the efficient synchronization of all entries in every related file, even when only a single entry has been altered and working with and synchronizing multiple files, large amounts of data, and sequential operations. Specifically, the configuration 400 describes how the data synchronization and delta engine causes the network server 102ₐ, (FIG. 1) to interact with the rest of the system 100. The on-premises process can be configured to run in parallel to the cloud-based process, but it may be tailored for execution without reliance on cloud-hosted components. Like the cloud version, the on-prem process performs daily delta comparisons and reconciliations between two structured data files to detect and process inserts, updates, and deletions.

According to FIG. 4, the configuration 400 can cause the enterprise network 101 (FIG. 1) to receive 402 stored parameters and perform 404 a comparison process based on files from two different sources 406, 408 within the system 100 (FIG. 1). For example, the comparison can be between a received file 114 (FIG. 1) and a gold, reference copy of a file 114 (FIG. 1). The configuration 400 can assess 410 whether the received file is empty and, if so, process 412 the file, which may include generating a token, manifest, and/or formatting the file. However, if the file is not empty, the process can further cause the enterprise network 101 (FIG. 1) to assess 414 whether or not the two files have equal headers. If they do not have equal headers, the configuration 400 can cause the enterprise network 101 (FIG. 1) to stop 416 to attempt to amend a mismatched header. If that is not possible, an error 418 may be generated. The error may include generation of an email notification alerting a user of the error.

In further reference to FIG. 4, the configuration 400 can cause the enterprise network 101 (FIG. 1) to process the two files based on an advance 422, 424 associated with each of the files. Such processing can include a flush the buffers, check tolerances, and notify a user of the results. Once complete, the files can be compared 426 based on their keys. If the key of the first file is greater than the key of the second file, the configuration 400 can cause the enterprise network 101 (FIG. 1) to assess 428 a base dimension, which can advance the first file. If the key of the first file is less than the key of the second file, the configuration 400 can cause the enterprise network 101 (FIG. 1) to create 430 an upsert, which can advance the second file. When the key of the first file is the same as the key of the second file, the configuration 400 can further cause the enterprise network 101 (FIG. 1) to assess whether or not the data in the first file is the same as the data in the second file. If so, the configuration 400 can cause the enterprise network 101 (FIG. 1) to advance the first file. If not, the configuration 400 can cause the enterprise network 101 (FIG. 1) to determine 434 any mismatches by attribute, select 440 a pattern buffer, and determine 438 whether or not that buffer has been filled. If the buffer has been filled, the configuration 400 can cause the enterprise network 101 (FIG. 1) to flush 442 the buffer to output and set a first buffer entry. If the buffer has not been filled, the configuration 400 can cause the enterprise network 101 (FIG. 1) to advance the first file.

Accordingly, the configuration 200 can enable the on-premises, enterprise network 101 (FIG. 1) to perform daily delta comparisons and reconciliations between two structured data files to detect and process inserts, updates, and deletions. This process is designed for automated daily delta and reconciliation of two sets of structured enterprise data files—typically delimited text files. It compares a “Gold Copy” (reference data) against cloud-hosted or on-premises variable-length files to identify inserts, updates, and deletions. The inputs may include a first file, or a reference “Gold Copy” in pipe-delimited format with headers, and a local on-premises system, variable-length version of the Gold Copy, also in pipe-delimited format with headers. The configuration 400 may operate on certain parameters dictate how the process handles data validation, transformation, and output. Examples of some parameters are provided below:

### Control Parameters:

The on-premises process uses the same parameter structures and logic as the cloud process:

### Run Control Parameters (e.g., PRM03-NYYYYN):

A: Abort on bad header/header mismatch.
B: Create SQL (or not); define action type (insert/update).
C: Create partial SQL statements.
D: Output record differences.
E: Use abbreviated attribute names.
F: Daily delta vs. reconciliation flag.
G: Batch SQL flag (for multi-update per record).

### Buffer Control Parameters (e.g., PRM0449-1700-22000-12000):

Define batch size, number of buffers, size of each buffer, and insert buffer size.
Tolerance Limits (e.g., PRM07-00000000-00000000-00000000):
Define upper bounds for acceptable inserts, deletes, and updates before flagging a reconciliation failure.

### Supplemental Files:

Token reference files: Define schemas and transformations for field alignment.
Manifest files: Track expected deletes and validate reconciliation completeness.

### Upsert Logic:

“Upsert” refers to update-if-present, insert-if-missing logic for processing records.

### Output:

Outputs are typically SQL statements or difference reports that document insertions, updates, and deletions between the two files.
The output can be used to update a local database or for audit and review purposes.

In other words, the configuration 200 can provide an on-premises process configure for use with the cloud version in functionality, using the same structured file formats, control parameters, and logic. However, it is entirely self-contained, operating on locally stored files and generating results that remain within the organization's internal data systems. This process is well-suited for environments where data cannot leave the premises due to regulatory, privacy, or latency constraints.

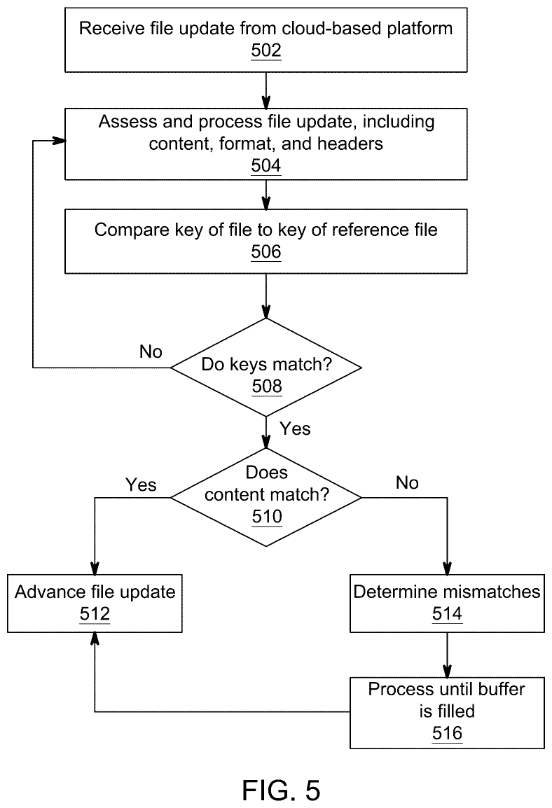

FIG. 5 is a flow diagram of a method 500 associated with the configuration of FIG. 4 according to one non-limiting aspect of the present disclosure. The method 500 can include receiving 502 a file update from a cloud-based platform and assessing and processing 504 the file update, including the content, format, and headers. Once processed, the method 500 can further include assessing 508 whether or not the keys between the file update and a reference file match. If the keys do not match, the method 500 can further include assessing and processing 504 the file update again. If the keys match, the method 500 can further include assessing 510 whether or not the data of the file update and a reference file match. If the data matches, the method 500 can further include advancing 512 the file update. However, if the data does not match, the method 500 can further include determining 514 any mismatches by attribute and processing 516 the file until a buffer is filled. Once the buffer is filled, the method 500 can further include advancing 512 the file update.

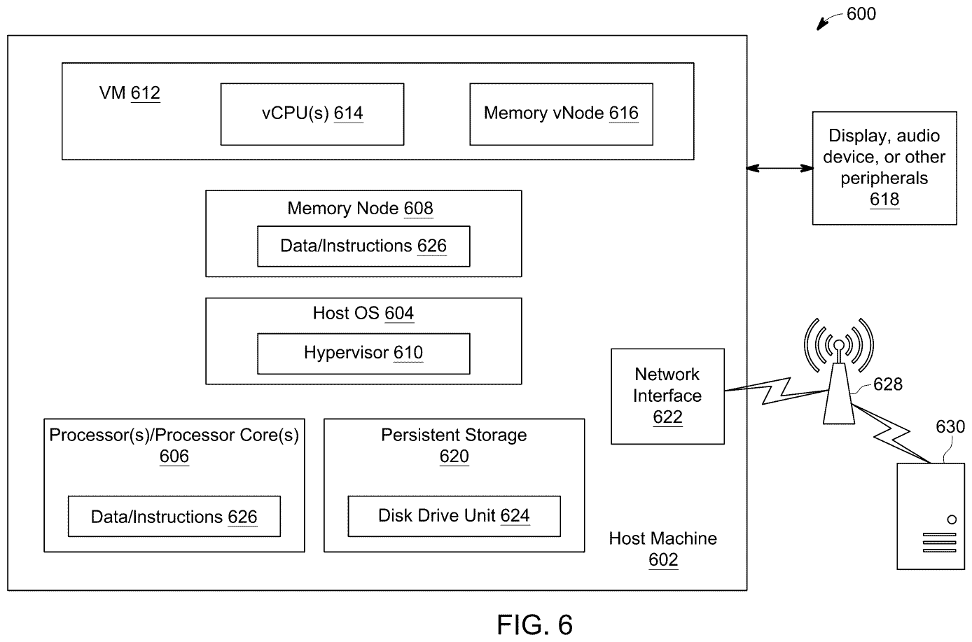

FIG. 6 depicts a computer system 600 configured for use with the system of FIG. 1 according to various non-limiting aspects of the present disclosure. The computer system 600 that includes a host machine 602 within which a set of instructions to perform any one or more of the methodologies discussed herein may be executed, according to at least one aspect of the present disclosure. In various aspects, the host machine 602 operates as a standalone device or may be connected (e.g., networked) to other machines. In a networked deployment, the host machine 602 may operate in the capacity of a server or a client machine in a server-client network environment, or as a peer machine in a peer-to-peer (or distributed) network environment. The host machine 602 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 600 includes the host machine 602, running a host operating system (OS) 604 on a processor or multiple processor(s)/processor core(s) 606 (e.g., a central processing unit (CPU), a graphics processing unit (GPU), or both), and various memory nodes 608. The host OS 604 may include a hypervisor 610 which is able to control the functions and/or communicate with a virtual machine (“VM”) 612 running on machine readable media. The VM 612 also may include a virtual CPU or vCPU 614. The memory nodes 608 may be linked or pinned to virtual memory nodes or vNodes 616. When the memory node 608 is linked or pinned to a corresponding vNode 616, then data may be mapped directly from the memory nodes 608 to the corresponding vNode 616.

All the various components shown in host machine 602 may be connected with and to each other, or communicate to each other via a bus (not shown) or via other coupling or communication channels or mechanisms. The host machine 602 may further include a video display, audio device or other peripherals 618 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 620 (also referred to as disk drive unit), and a network interface device 622. The host machine 602 may further include a data encryption module (not shown) to encrypt data. The components provided in the host machine 602 are those typically found in computer systems that may be suitable for use with aspects of the present disclosure and are intended to represent a broad category of such computer components that are known in the art. Thus, the system 600 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 624 also may be a Solid-state Drive (SSD), a hard disk drive (HDD) or other includes a computer or machine-readable medium on which is stored one or more sets of instructions and data structures (e.g., data/instructions 626) embodying or utilizing any one or more of the methodologies or functions described herein. The data/instructions 626 also may reside, completely or at least partially, within the main memory node 608 and/or within the processor(s) 606 during execution thereof by the host machine 602. The data/instructions 626 may further be transmitted or received over a network 628 via the network interface device 622 utilizing any one of several well-known transfer protocols (e.g., Hyper Text Transfer Protocol (HTTP)).

The processor(s) 606 and memory nodes 608 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 602 and that causes the host machine 602 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 602, with each server 630 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In one general aspect, therefore, the present invention is directed to a computer-implemented method for updating files hosted by a cloud-based platform. The method can include receiving, via a programmed computer system that comprises one or more processors, a target file, wherein the target file has at least one updated data entry associated with a customer or customer account, authenticating, via the one or more processors of the programmed computer system, a request to process the at least one updated data entry of the target file, staging, via the one or more processors of the programmed computer system, the target file for processing prior to processing the at least one updated data entry of the target file, assessing, via the one or more processors of the programmed computer system, a data format of the target file, and generating, via the one or more processors of the programmed computer system, a triggering event based on the data format of the target file. If the data format of the target file comprises a property name and value, the triggering event is configured to cause a stream listener of the cloud-based platform to process the at least one updated data entry of the target file without a merge operation. If the data format of the target file comprises delimiters and headers, the triggering event is configured to cause the stream listener of the cloud-based platform to perform a merge operation prior to processing the at least one updated data entry of the target file.

In various implementations, the method comprises the steps of detecting, via the stream listener of the cloud-based platform, the triggering event, and in response to detecting the triggering event, processing, via the stream listener of the cloud-based platform, the at least one updated data entry of the target file.

In various implementations, the method comprises the steps of detecting, via the stream listener of the cloud-based platform, the triggering event, and in response to detecting the triggering event, performing, via the stream listener of the cloud-based platform, a merge operation associated with the target file.

In various implementations, the method comprises the step of processing, via the stream listener of the cloud-based platform, the at least one updated data entry of the target file in response to performing the merge operation.

In various implementations, the method comprises the step of receiving, via the one or more processors of the programmed computer system, a token associated with the target file, wherein the token associated with the target file comprises a security credential, and wherein authenticating the request to process the at least one updated data entry of the target file is based on the security credential.

In various implementations, staging the target file for processing comprises at least one of validating, transforming, auditing, or enriching the target file, or combinations thereof.

In various implementations, staging the target file for processing comprises reconciling errors in the target file.

In various implementations, the method comprises the step of analyzing, via the one or more processors of the programmed computer system, the target file prior to processing.

In various implementations, analyzing the target file comprises assessing, via the one or more processors of the programmed computer system, whether a manifest associated with the target file comprises data within the target file.

In various implementations, analyzing the target file comprises assessing, via the one or more processors of the programmed computer system, whether a name of the target file matches a name of a corresponding file stored in a cloud-based storage of the cloud-based platform.

In various implementations, analyzing the target file comprises assessing, via the one or more processors of the programmed computer system, a number of records associated with the target file in comparison to a number of records in a corresponding file stored in a cloud-based storage of the cloud-based platform.

In various implementations, the method comprises the step of re-writing, via the one or more processors of the programmed computer system, a portion of the target file based on the analysis.

In another general aspect, therefore, the present invention is directed to a computer-implemented method for updating files hosted by a cloud-based platform. The method can include receiving, via one or more processors of a cloud-based computing system, a target file, wherein the target file has at least one updated data entry associated with a customer or customer account, accessing, via the one or more processors of the cloud-based computer system, a reference file stored in cloud-based storage, the reference file comprising existing data records associated with the customer or customer account, comparing, via the one or more processors of the cloud-based computer system, a key associated with the target file with a key associated with a reference file to identify whether a matching data record exists, in response to identifying a matching key, comparing, via the one or more processors of the cloud-based computer system, the data entry of the target file to a corresponding data entry in the reference file, determining, via the one or more processors of the cloud-based computer system, whether the data entry in the target file is redundant with respect to the reference file; and in response to determining that the data entry is not redundant, forwarding, via the one or more processors of the cloud-based computer system, the target file to a processing queue for committing the updated data entry to the cloud-based storage system.

In various implementations, the method comprises the step of determining, via the processor, any mismatches between the target file and the reference file associated with the reference file by attribute if the data within the target file is not equal to the data within the reference file.

In various implementations, the method comprises the step of selecting, via the processor, a pattern buffer.

In various implementations, the method comprises the step of determining, via the processor, that the buffer has been filled, and wherein advancing the target file, including the at least one updated data entry, is based on the determination that the buffer has been filled.

In another general aspect, therefore, the present invention is directed to a computer system configured to update files hosted by a cloud-based platform. The computer system can include one or more processors and a memory in communication with the one or more processors, wherein the memory stores a data synchronization and delta engine that, when executed by the one or more processors, causes the one or more processors to perform operations comprising receiving a target file, wherein the target file has at least one updated data entry associated with a customer or customer account, authenticating a request to process the at least one updated data entry of the target file, staging the target file in a pre-processing memory location to process the target file prior to committing the updated data entry, analyzing a format of the target file to determine whether the target file comprises (i) property names and values or (ii) delimited data with headers, and generate a triggering event based on the format of the target file; and invoking a stream listener module stored in the memory and executable by the one or more processors, the stream listener module being configured to process the updated data entry without a merge operation if the target file comprises property names and values; and perform a merge operation to reconcile the updated data entry with a corresponding data record prior to processing if the target file comprises delimited data with headers.

In various implementations, when executed by the one or more processors, the data synchronization and delta engine further causes the computer system to detect the triggering event, and in response to detecting the triggering event, process the at least one updated data entry of the target file.

In various implementations, when executed by the one or more processors, the data synchronization and delta engine further causes the computer system to detect the triggering event, and in response to detecting the triggering event, perform a merge operation associated with the target file.

In various implementations, in response to performing the merge operation, the computer system can process the at least one updated data entry of the target file.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various aspects have been described herein, it should be apparent that various modifications, alterations, and adaptations to those aspects may occur to persons skilled in the art with attainment of at least some of the advantages. The disclosed aspects are therefore intended to include all such modifications, alterations, and adaptations without departing from the scope of the aspects as set forth herein.

1. A computer-implemented method for updating files hosted by a cloud-based platform, the method comprising:
receiving, via a programmed computer system that comprises one or more processors, at least two target files, wherein each target file has at least one updated data entry associated with a customer or customer account;
authenticating, via the one or more processors of the programmed computer system, a request to process the at least one updated data entry of each target file;
staging, via the one or more processors of the programmed computer system, each target file for processing prior to processing the at least one updated data entry of the target file;
assessing, via the one or more processors of the programmed computer system, a data format of each target file, wherein accessing the data format of each target file comprises:
determining at least one target file comprises a first data format; and
determining at least one target file comprises a second data format;
wherein the first data format comprises a property name and value, and wherein the second data format comprises delimiters and headers; and
generating, via the one or more processors of the programmed computer system, a triggering event for each target file based on the data format of the target file, wherein:
for each target file comprising the first data format, the triggering event is configured to cause a stream listener of the cloud-based platform to process the at least one updated data entry of the target file without a merge operation; and
for each target file comprising the second data format, the triggering event is configured to cause the stream listener of the cloud-based platform to perform a merge operation prior to processing the at least one updated data entry of the target file.

2. The method of claim 1, further comprising:
detecting, via the stream listener of the cloud-based platform, the triggering event for a first target file; and
in response to detecting the triggering event, processing, via the stream listener of the cloud-based platform, the at least one updated data entry of the first target file.

3. The method of claim 1, further comprising:
detecting, via the stream listener of the cloud-based platform, the triggering event for a second target file; and
in response to detecting the triggering event, performing, via the stream listener of the cloud-based platform, a merge operation associated with the second target file.

4. The method of claim 3, further comprising:
in response to performing the merge operation, processing, via the stream listener of the cloud-based platform, the at least one updated data entry of the second target file.

5. The method of claim 1, wherein the stream listener is remotely located relative to the one or more processors of the programmed computer system.

6. The method of claim 1, wherein staging each target file for processing comprises, for each target file, at least one of validating, transforming, auditing, or enriching the target file, or combinations thereof.

7. The method of claim 1, wherein staging each target file for processing comprises, for at least one target file, reconciling errors in the target file.

8. The method of claim 1, further comprising:
analyzing, via the one or more processors of the programmed computer system, at least one target file prior to processing.

9. The method of claim 8, wherein analyzing the at least one target file prior to processing comprises assessing, via the one or more processors of the programmed computer system, the at least one target file for the data format.

10. The method of claim 1, further comprising:
generating, via the one or more processors of the programmed computer system, at least one target file in the data format, wherein the data format is selected based on a potential merge operation to be performed by the cloud-based platform.

11. The method of claim 1, further comprising:
configuring, via the one or more processors of the programmed computer system, at least one target file based on whether the cloud-based platform should perform a merge operation associated with the target file.

12. The method of claim 11, wherein configuring the at least one target file comprises changing, via the one or more processors of the programmed computer system, an original data format of the at least one target file.

13. A computer-implemented method for updating files hosted by a cloud-based platform, the method comprising:
receiving, via one or more processors of a cloud-based computing system, at least two target files, wherein each target file has at least one updated data entry associated with a customer or customer account, wherein at least one target file comprises a first data format and at least one target file comprises a second data format, wherein the first data format comprises a property name and value, and wherein the second data format comprises delimiters and headers;
accessing, via the one or more processors of the cloud-based computer system, a reference file stored in cloud-based storage, the reference file comprising existing data records associated with the customer or customer account;
comparing, via the one or more processors of the cloud-based computer system, a key associated with the target file with a key associated with the reference file to identify whether a matching data record exists;
in response to identifying a matching key, comparing, via the one or more processors of the cloud-based computer system, the data entry of the target file to a corresponding data entry in the reference file;
determining, via the one or more processors of the cloud-based computer system, whether the data entry in the target file is redundant with respect to the reference file; and in response to determining that the data entry is not redundant, forwarding, via the one or more processors of the cloud-based computer system, the target file to a processing queue for committing the updated data entry to the cloud-based storage system; and
for each target file comprising the first data format, causing a stream listener of the cloud-based computer system to process the at least one updated data entry of the target file without a merge operation; and
for each target file comprising the second data format, causing the stream listener of the cloud-based computer system to perform a merge operation prior to processing the at least one updated data entry of the target file.

14. The method of claim 13, further comprising:
if the data within the target file is not equal to the data within the reference file, determining, via the processor, any mismatches between the target file and the reference file by attribute.

15. The method of claim 13, further comprising:
selecting, via the processor, a buffer, wherein the buffer is defined by a plurality of buffer control parameters.

16. The method of claim 15, further comprising:
determining, via the processor, that the buffer has been filled, and wherein forwarding the target file, including the at least one updated data entry, is based on the determination that the buffer has been filled.

17. A computer system configured to update files hosted by a cloud-based platform, the computer system comprising:
one or more processors; and
a memory in communication with the one or more processors, wherein the memory stores a data synchronization and delta engine that, when executed by the one or more processors, causes the one or more processors to perform operations comprising:
receiving at least two target files, wherein each target file has at least one updated data entry associated with a customer or customer account;
authenticating a request to process the at least one updated data entry of each target file;
staging each target file in a pre-processing memory location to process the target file prior to committing the updated data entry;
analyzing a format of each target file to determine whether the target file comprises a first data format or a second data format, wherein the first data format comprises property names and values, wherein the second data format comprises delimited data with headers, wherein at least one target file comprises a first data format and at least one target file comprises a second data format; and
generate a triggering event based on the format of the target file; and
invoking a stream listener module stored in the memory and executable by the one or more processors, the stream listener module being configured to:
for the at least one target file comprising the first data format, process the updated data entry without a merge operation; and
for the at least one target file comprising the second data format, perform a merge operation to reconcile the updated data entry with a corresponding data record prior to processing.

18. The computer system of claim 17, wherein, when executed by the one or more processors, the data synchronization and delta engine further causes the computer system to:
detect the triggering event; and
in response to detecting the triggering event, process the at least one updated data entry of each target file.

19. The computer system of claim 17, wherein, when executed by the one or more processors, the data synchronization and delta engine further causes the computer system to:
detect the triggering event; and
in response to detecting the triggering event, perform a merge operation associated with a first target file.

20. The computer system of claim 19, wherein, when executed by the one or more processors, the data synchronization and delta engine further causes the computer system to:
in response to performing the merge operation, process the at least one updated data entry of the first target file.
